(19) United States
(12) Patent Application Publication
(10) Pub. No.: US 2009/0310901 A1
(43) Pub. Date: Dec. 17, 2009

(54) High speed optical modulator

(76) Inventor: Po Dong, Arcadia, CA (US)

Correspondence Address: ATTN: Travis Dodd;GAVRILOVICH, DODD & LINDSEY, LLP, 2490 Heyneman Hollow, Fallbrook, CA, 92028, US

(21) Appl. No.: 12/319,718

(22) Filed: Jan. 8, 2009

Related U.S. Application Data
(60) Provisional application No. 61/132,151, filed on Jun. 16, 2008.

(51) Int. Cl. G02F 1/025

(52) U.S. Cl. 385/3

(57) ABSTRACT

The modulator includes an optical waveguide positioned on a base. The waveguide is configured to guide a light signal through a light signal-carrying region of a light-transmitting medium. The light signal-carrying region is a region of the waveguide where a fundamental and higher order modes of the light signal are constrained within the waveguide. The modulator also includes a bipolar junction transistor formed in the light-transmitting medium. The bipolar junction transistor is positioned such that causing current to flow through the transistor causes charge carriers to be introduced into the light signal-carrying region of the waveguide.

### RELATED APPLICATIONS

This application claims the benefit of U.S. Provisional Patent application serial No. 61/132,151, filed on Jun. 16, 2008, entitled “High Speed Optical Modulator” and incorporated herein in its entirety.

### FIELD

The present invention relates to optical devices and more particularly to optical modulators.

### BACKGROUND

Optical modulators are used to encode information onto light signals. It is desirable to encode information at a rate of about 10 to 40 Gbps. However, encoding data at these rates has proven difficult due to the limitations of optics and the associated electronics. One example of a modulator includes an optical waveguide having one or more doped regions that contact one another so as to form a depletion region in the waveguide. Electrical energy is applied to the waveguide so as to tune the size and/or shape of the depletion region. These modulators are often associated with large levels of optical loss. Additionally, these modulators often require that undesirably high levels of electrical energy be applied to the modulator in order to achieve a particular level of modulation. As a result, there is a need for an improved optical modulator.

### SUMMARY

The modulator includes an optical waveguide positioned on a base. The waveguide is configured to guide a light signal through a light signal-carrying region of a light-transmitting medium. The light signal-carrying region is a region of the waveguide where fundamental and higher order modes of the light signal are constrained within the waveguide. The modulator also includes one or more bipolar junctions transistors formed in the light-transmitting medium. Each of the bipolar junction transistors is positioned such that causing electrical current to flow through the transistor causes charge carriers to flow through the light signal-carrying region of the waveguide.

In some instances, the bipolar junction transistor includes three primary doped regions of the light-transmitting medium. Each one of the primary doped regions contacts one or more of the other primary doped regions but two of the doped primary regions do not contact one another. At least one of the primary doped regions is positioned in the light signal-carrying region.

The primary doped regions can include a first doped region that is the only one of the primary doped regions positioned in the light signal-carrying region. In some instances, the light signal-carrying region does not extend outside of the first doped region.

The modulator can include electronics configured to operate the bipolar junction transistor such that one of the primary doped regions act as a collector for the transistor, one of the primary doped regions act as a base for the transistor, and one of the primary doped regions act as an emitter for the transistor. The primary doped region that acts as the collector can be the first doped region.

### BRIEF DESCRIPTION OF THE FIGURES

FIG. 1A and FIG. 1B illustrate an optical device. FIG. 1A is a top-view of the optical device.

FIG. 1B is a cross section of the optical device shown in FIG. 1B taken along the line labeled B in FIG. 1A, which includes a horizontal bipolar junction transistor structure.

FIG. 2 is a cross section of an optical device having a phase modulator that includes multiple bipolar junction transistors that share a common doped region positioned in the signal-carrying region of a waveguide.

FIG. 3 is a cross section of an optical device having a phase modulator that includes three of the primary doped regions positioned in the signal-carrying region of a waveguide, which includes a vertical bipolar junction transistor structure.

### DESCRIPTION

A phase modulator is disclosed for the modulation of a light signal traveling through a waveguide. The phase modulator includes an optical waveguide configured to guide a light signal through a light signal-carrying region of a light-transmitting medium. The phase modulator includes a bipolar junction transistor positioned such that causing current to flow through the bipolar junction transistor causes charge carriers to flow into the light signal-carrying region of the waveguide. The charge carriers alter the index of refraction of the light signal-carrying region. As a result, changing the concentration of charge carriers in the light signal-carrying region changes the speed at which the light signal travels through the waveguide. Accordingly, the speed of the light signal through the waveguide can be tuned by operating the bipolar junction transistor so as to change the concentration of charge carriers in the light signal-carrying region. Tuning the speed at which the light signal travels through the waveguide allows the modulator to be employed as a phase modulator.

The use of a bipolar junction transistor increases the change in the index of refraction of the light-transmitting medium that can be achieved per unit of electrical energy applied to the modulator above the level that can be achieved with modulators that modulate depletion regions. As a result, the use of a bipolar junction transistor can increase the efficiency of the modulator above the level that can be achieved with prior modulators.

Additionally, the use of a bipolar junction transistor can also reduce the optical loss associated with the phase modulator. For instance, the bipolar junction transistor can include three doped regions in the light-transmitting medium with each the doped regions contacting one or more of the other doped regions. At least one of the doped regions can be positioned in the light signal-carrying region of the light-transmitting medium. Operating the bipolar junction transistor such that charge carriers are introduced into the one or more doped regions that are positioned in the light signal-carrying region causes the modulation of the light signal traveling through the light signal-carrying region. In some instances, only one of the doped regions is positioned in the light signal-carrying region of the light-transmitting medium. As a result, a junction between adjacent doped regions is not positioned in the light signal-carrying region. Since the location of such a junction in the light signal-carrying region of a waveguide is a source of optical loss, the removal of this junction from the light signal-carrying region reduces the optical loss associated with the modulator.

Additionally, the use of bipolar junction transistors is faster than MOS transistors and is not limited by free-carrier recombination times. As a result, the use of a bipolar junction transistor provides a phase modulator with an enhanced efficiency.

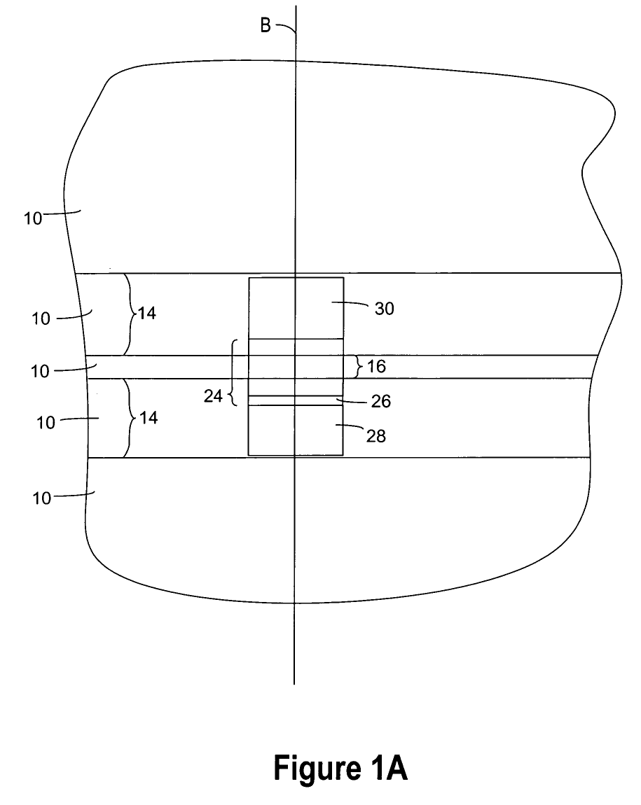

FIG. 1A and FIG. 1B illustrate an optical device. FIG. 1A is a top-view of the optical device. FIG. 1B is a cross section of the optical device shown in FIG. 1B taken along the line labeled B in FIG. 1A. A portion of the features illustrated in FIG. 1B are not shown in FIG. 1A in order to simplify the illustration. For instance, a tertiary doped region, first electrical conductor, second electrical conductor, third electrical conductor, and upper medium are each discussed below but not shown in FIG. 1A.

The device includes a light-transmitting medium 10 positioned on a base 12. A suitable light-transmitting medium 10 includes, but is not limited to, semiconductors such as silicon. Recesses 14 are formed in the light-transmitting medium 10 so as to define a ridge 16 extending from a slab 17 of the first light-transmitting medium 10. The ridge 16 and the base 12 each define a portion of a light signal-carrying region. The light signal-carrying region is the region of the waveguide where the fundamental mode 18 of the light signals is guided or where the fundamental mode and the higher order modes are guided. Alternately, the light signal-carrying region is the region of the first light-transmitting medium 10 where the fundamental mode of the light signals is guided or where the fundamental mode and the higher order modes are guided. For instance, the materials that contact the ridge 16 have an index of refraction less than the index of refraction of the light-transmitting medium 10. The reduced index of refraction reflects light signals from the ridge 16 back into the ridge 16. Additionally, the portion of the base 12 contacting the light-transmitting medium 10 under the ridge 16 can have an index of refraction less than the index of refraction of the light-transmitting medium 10. The reduced index of refraction reflects light signals from the light-transmitting medium 10 back into the light-transmitting medium 10. As a result, the fundamental mode and the higher order modes are constrained within the light signal-carrying region of the waveguide.

The base 12 illustrated in FIG. 1B includes an insulator 19 positioned over a substrate 20. When the light-transmitting medium 10 is silicon, a suitable insulator 19 includes, but is not limited to, silica and a suitable substrate 20 includes a silicon substrate. A silicon-on-insulator wafer is a suitable platform for an optical device and has a silicon light-transmitting medium 10 positioned over a base 12 that has a silica insulator 19 and a silicon substrate 20.

An upper medium 22 is positioned on the light-transmitting medium. The upper medium 22 can include one or more layers. Suitable materials for the layers include, but are not limited to, low K dielectrics such as silica, and/or silicon nitride. One or more of the layers can be selected to provide optical and/or electrical confinement. For instance, as noted above, the layer of the upper medium 22 in contact with the light-transmitting medium or the ridge can provide optical confinement by having an index of refraction that is less than the index of refraction of the light-transmitting medium.

There are three primary doped regions in the light-transmitting medium. The primary doped regions include a first doped region 24, a second doped region 26, and a third doped region 28. The primary doped regions form a bipolar junction transistor having the second doped region 26 between the first doped region 24 and the third doped region 28. Each of the primary doped regions contacts one or more of the other primary doped regions. For instance, the bipolar junction transistor includes two junctions. One of the junctions is where the first doped region 24 contacts the second doped region 26 and another one of the junctions is where the second doped region 26 contacts the third doped region 28. In some instances, the bipolar junction transistor includes no more than two junctions. For instance, in addition to the two junctions described above, the first doped region 24 does not contact the third doped region 28.

The bipolar junction transistor can be a PNP type transistor or can be an NPN type transistor. For instance, the first doped region 24 and the third doped region 28 can include P-type dopants and can accordingly be P-type regions while the second doped region 26 can include an N-type dopant and can accordingly be a N-type region. Alternately, the first doped region 24 and the third doped region 28 can include N-type dopants and can accordingly be N-type regions while the second doped region 26 can include an P-type dopant and can accordingly be a P-type region. Suitable dopants for n-type regions include, but are not limited to, phosphorus and/or arsenic. Suitable dopants for p-type regions include, but are not limited to, boron.

There is a secondary doped region 30 in the light-transmitting medium. The secondary doped region 30 contacts the first doped region 24 and does not contact the second doped region 26 or the third doped region 28. The secondary doped region 30 can serve to provide electrical communication between a first electrical conductor 32 that extends through the upper medium 22 and the first doped region 24. The type of dopant in the secondary doped region 30 and the first doped region 24 can be the same, however, the concentration of the dopant in the secondary doped region 30 can be higher than the concentration of the dopant in the first doped region 24. As an example, when the first doped region 24 is a P-type region, the concentration of P-type dopant in the secondary doped region 30 can exceed the concentration of the P-type dopant in the first doped region 24. Although it is possible to place the first electrical conductor 32 directly into contact with the first doped region 24 rather than use the secondary doped region 30, the increased dopant concentration in the secondary doped region 30 reduces the resistance associated with direct electrical communication between the first electrical conductor 32 and the first doped region 24. A suitable material for the first electrical conductor 32 includes, but is not limited to, a metal.

There is a tertiary doped region 36 in the upper medium 22. The tertiary doped region 36 contacts the second doped region 26 and does not contact the first doped region 24 or the third doped region 28. The tertiary doped region 36 can serve to provide electrical communication between a second electrical conductor 38 on the upper medium 22 and the second doped region 26. The type of dopant in the tertiary doped region 36 and the second doped region 26 can be the same, however, the concentration of the dopant in the tertiary doped region 36 can be higher than the concentration of the dopant in the second doped region 26. As an example, when the second doped region 26 is an N-type region, the concentration of the N-type dopant in the tertiary doped region 36 can exceed the concentration of the N-type dopant in the second doped region 26. Although it is possible to place the second electrical conductor 38 directly into contact with the second doped region 26 rather than use the tertiary doped region 36, the tertiary doped region 36 reduces the resistance associated with direct electrical communication between the second electrical conductor 38 and the second doped region 26. A suitable material for the second electrical conductor 38 includes, but is not limited to, a metal.

In some instances, the material that is doped in the tertiary doped region 36 is different than the material in the upper medium 22. For instance, the doped material in the tertiary doped region 36 can be silicon or polysilicon while the upper medium 22 is silica. The use of doped silicon or polysilicon can further reduce the electrical resistance associated with electrical communication between the second electrical conductor 38 and the second doped region 26.

A third electrical conductor 40 extends through the upper medium 22 and into contact with the third doped region 28. The concentration of the dopant in the third doped region 28 can be higher than the concentration of dopant in the first doped region 24 and in the second doped region 26. The reduced electrical resistance associated with the elevated dopant concentration reduces the need for an additional doped region between the third electrical conductor 40 and the third doped region 28 although an additional doped region could be employed. A suitable material for the third electrical conductor 40 includes, but is not limited to, a metal.

Electronics can be in electrical communication with the first electrical conductor 32, the second electrical conductor 38, and the third electrical conductor 40. The electronics can be employed to apply electrical energy to the first doped region 24, the second doped region 26, and the third doped region 28. The electronics can apply the electrical energy so the bipolar junction transistor is operated with the first doped region 24 as the collector, the second doped region 26 as the base, and the third doped region 28 as the emitter. For instance, the electronics can apply a forward bias between the third doped region 28 and the second doped region 26 and a reverse bias between the second doped region 26 and the first doped region 24. Alternately, the electronics can apply the electrical energy so the bipolar junction transistor is operated with the first doped region 24 as the emitter, the second doped region 26 as the base, and the third doped region 28 as the collector. For instance, the electronics can apply a reverse bias between the third doped region 28 and the second doped region 26 and a forward bias between the second doped region 26 and the first doped region 24. However, in circumstances where the concentration of the dopant in the third doped region 28 is higher than the concentration of the dopant in the first doped region 24, it may be desirable for the electronics to operate the bipolar junction transistor with the first doped region 24 serving as the collector.

Changing the current flow through the bipolar junction transistor changes the number of charge carriers in the first doped region 24. A charge carrier is a free (mobile and/or unbound) particle carrying an electric charge. Examples are electrons and ions. The travelling vacancies in the valence-band electron population (holes) are treated as charge carriers. When the bipolar junction transistor is an PNP transistor and the bipolar junction transistor is operated such that the first doped region 24 serves as the collector, increasing the current flow through the first doped region 24 increases the concentration of holes in the first doped region 24. In contrast, when the bipolar junction transistor is an NPN transistor and the bipolar junction transistor is operated such that the first doped region 24 serves as the collector, increasing the current flow through the first doped region 24 increases the concentration of electrons in the first doped region 24. Since the first doped region 24 includes the light signal-carrying of the waveguide, changing the concentration of charge carriers in the first doped region alters the index of refraction of the light signal-carrying region and accordingly changes the speed at which the light signal travels through the waveguide. Accordingly, the speed of the light signal through the waveguide can be tuned by tuning the flow of electrical current through the bipolar junction transistor and particularly through the light-signal-carrying region. For instance, the speed of the light signal through the waveguide can be tuned by tuning the flow of electrical current through the first doped region 24.

The bipolar junction transistor can be constructed such that one or more of the primary doped regions are positioned within the light signal-carrying region of the waveguide. As is evident in FIG. 1A and FIG. 1B, the bipolar junction transistor is preferably be constructed such that no more than one of the primary doped regions is positioned within the light signal-carrying region of the waveguide and the other primary doped regions are excluded from the light signal-carrying region. Additionally or alternately, the light signal-carrying region can include no more than one of the primary doped regions and can exclude the other primary doped regions. In one example, the bipolar junction transistor is preferably constructed such that only the first doped regions 24 is positioned within the light signal-carrying region and the second doped region 26 and the third doped regions 28 are excluded from the light signal-carrying region. When no more than one of the primary doped regions is located in the light signal-carrying region, the light signal-carrying region excludes junctions between doped region and the modulator is accordingly not associated with the optical loss resulting from these junctions.

In some instance, the light signal-carrying region does not extend outside of the primary doped regions. For instance, the bipolar junction transistor can be constructed such that the light signal-carrying region does not extend beyond one of the primary doped regions. FIG. 1A and FIG. 1B illustrate the bipolar junction transistor constructed such that the light signal-carrying region does not extend beyond the first doped region 24. Constructing the bipolar junction transistor without the light signal-carrying region extending beyond one of the primary doped regions can enhance the efficiency of the modulator by increasing the portion of the light signal-carrying region that is exposed to the injected charge carriers.

The maximum modulation speed that can be achieved by the bipolar junction transistor can be a function of the width of the second doped region 26 (labeled W in FIG. 1B). For instance, decreasing the width of the second doped region 26 can increase the maximum possible modulation speed. A suitable width for the second doped region 26 includes a width less than 5 μm, 2 μm, or 0.5 μm.

A suitable concentration for the dopant in the first doped region 24 includes concentrations greater than 1×10¹⁰/cm³, 1×10¹³/cm³, or 1×10¹⁵/cm³ and/or less than 1×10¹⁷/cm³, 1×10¹⁹/cm³, or 1×10²¹/cm³. In one example, the first doped region 24 is a p-type dopant with a concentration of about 4×10¹⁶/cm³. A suitable concentration for the dopant in the second doped region 26 includes concentrations greater than 1×10¹⁴/cm³, 1×10¹⁶/cm³, or 1×10¹⁸/cm³ and/or less than 1×10¹⁷/cm³, 1×10¹⁹/cm³, or 1×10²¹/cm³. In one example, the second doped region 26 is an n-type dopant with a concentration of about 1×10¹⁷/cm³. A suitable concentration for the dopant in the third doped region 28 includes concentrations greater than 1×10¹⁵/cm³, 1×10¹⁷/cm³, or 1×10¹⁹/cm³ and/or less than 1×10¹⁷/cm³, 1×10¹⁹/cm³, or 1×10²¹/cm³. In one example, the third doped region 28 is a p-type dopant with a concentration of about 1×10²⁰/cm³. A suitable concentration for the dopant in the secondary doped region 30 includes concentrations greater than 1×10¹⁷/cm³, 1×10¹⁹/cm³, or 5×10¹⁹/cm³ and/or less than 1×10¹⁸/cm³, or 1×10²⁰/cm³, or 1×10²²/cm³. In one example, the secondary doped region 30 is a p-type dopant with a concentration of about 1×10²⁰/cm³. A suitable concentration for the dopant in the tertiary doped region 36 include concentrations greater than 1×10¹⁶/cm³, 1×10¹⁸/cm³, or 1×10²⁰/cm³ and/or less than 1×10¹⁹/cm³, 1×10²⁰/cm³, or 1×10²²/cm³. In one example, the tertiary doped region 36 is an n-type dopant with a concentration of about 1×10²⁰/cm³.

A first dopant ratio (concentration of the dopant in the secondary doped region 30: concentration of the dopant in the first doped region 24) can be greater than 1:1, 10:1, or 100:1 and/or less than 1×10⁶, 1×10⁸, or 1×10¹⁰. A second dopant ratio (concentration of the dopant in the third doped region 28: concentration of the dopant in the second doped region 26) can be greater than 1:1, 10:1, 100:1 and/or less than 100:1, 1×10⁴:1, 1×10⁸. A third dopant ratio (concentration of the dopant in the third doped region 28: concentration of the dopant in the first doped region 24) can be greater than 1:1, 1×10²:1, or 1×10⁴:1 and/or less than 1×10²⁰:1, 1×10¹⁶:1, 1×10¹²:1. A fourth dopant ratio (concentration of the dopant in the tertiary doped region 36: concentration of the dopant in the second doped region 26) can be greater than 1:1, 1×10²:1, or 1×10⁴:1 and/or less than 1×10⁸:1, 1×10⁶:1, or 1×10⁴:1.

Although the primary doped regions are shown extending through the first light-transmitting medium 10, the primary doped regions can extend only part way into the first light-transmitting medium 10.

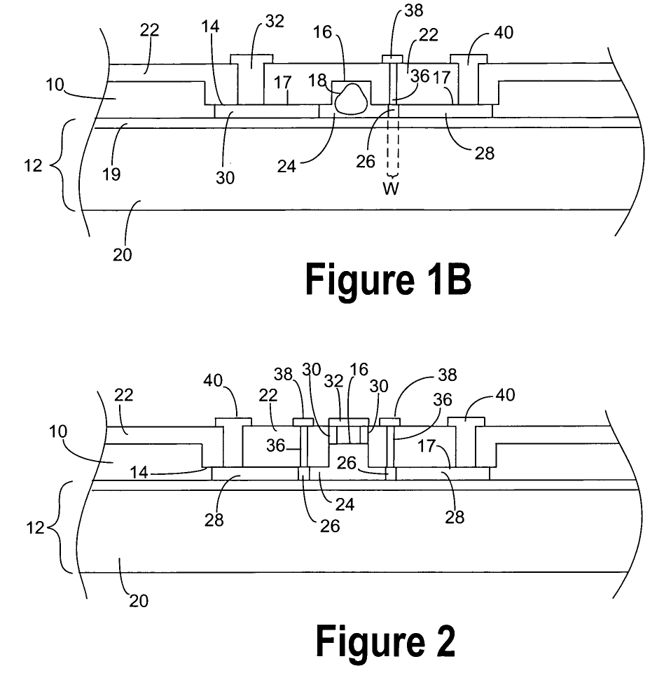

The modulator can include more than one bipolar junction transistor with each of the bipolar junction transistors positioned such that causing current to flow through the bipolar junction transistor causes charge carriers to flow into the light signal-carrying region of the waveguide. For instance, FIG. 2 is a cross section of an optical device having multiple bipolar junction transistors that share a common doped region.

There are multiple doped regions in the light-transmitting medium. There is one first doped region 24, two second doped regions 26, and two third doped regions 28. The primary doped regions form two bipolar junction transistors across the waveguide. Each bipolar junction transistor has a second doped region 26 between the first doped region 24 and a third doped region 28. One of the primary doped regions is common to both transistors. For instance, the transistors illustrated in FIG. 2 share the primary doped region but do not share a second doped region or a third doped region. Each of the primary doped regions included in one of the transistors contacts one or more of the other primary doped regions. For instance, each of the bipolar junction transistors includes two junctions. One of the junctions is where the first doped region 24 contacts one of the second doped regions 26 and another one of the junctions is where each of the second doped region 26 contacts one of the third doped region 28. In some instances, each of the bipolar junction transistors includes no more than two junctions. For instance, in addition to the two junctions described above, the first doped region 24 does not contact either of the third doped regions 28.

The second doped regions 26 can have the same type of dopant and the third primary doped regions can have the same type of dopant. As a result, each of the bipolar junction transistors can be a PNP type transistor or can be an NPN type transistor. For instance, the first doped region 24 and each of the third doped regions 28 can include P-type dopants and can accordingly be P-type regions while the second doped regions 26 each include an N-type dopant and can accordingly be N-type regions. Alternately, the first doped region 24 and the third doped regions 28 can each include N-type dopants and can accordingly be N-type regions while the second doped regions 26 can each include a P-type dopant and can accordingly be P-type regions. Suitable dopants for n-type regions include, but are not limited to, phosphorus and/or arsenic. Suitable dopants for p-type regions include, but are not limited to, boron.

There are secondary doped regions 30 in the upper medium 22. The secondary doped regions 30 each contacts the top of the ridge 16 and are spaced apart on the top of the ridge 16. In some instances, the secondary doped regions 30 contact opposing corners of the ridge 16. The secondary doped regions 30 each contacts the first doped region 24 and do not contact the second doped region 26 or the third doped region 28. The secondary doped region 30 can serve to provide electrical communication between the first doped region 24 and a first electrical conductor 32 on the upper medium 22. The type of dopant in the secondary doped region 30 and the first doped region 24 can be the same, however, the concentration of the dopant in the secondary doped region 30 can be higher than the concentration of the dopant in the first doped region 24. As an example, when the first doped region 24 is a P-type region, the concentration of P-type dopant in the secondary doped region 30 can exceed the concentration of the P-type dopant in the first doped region 24. Although it is possible to place the first electrical conductor 32 directly into contact with the first doped region 24 rather than use the secondary doped region 30, the increased dopant concentration in the secondary doped region 30 reduces the resistance associated with direct electrical communication between the first electrical conductor 32 and the first doped region 24. A suitable material for the first electrical conductor 32 includes, but is not limited to, a metal.

In some instances, the material that is doped in the secondary doped regions 30 is different than the material in the upper medium 22. For instance, the doped material in the secondary doped regions 30 can be silicon or polysilicon while the upper medium 22 is silica. The use of doped silicon or polysilicon can further reduce the electrical resistance associated with electrical communication between the second electrical conductor 38 and the second doped region 26.

There are tertiary doped regions 36 in the upper medium 22. The tertiary doped region 36 each contacts one of the second doped region 26 but does not contact either of the first doped regions 24 or the third doped regions 28. The tertiary doped region 36 can serve to provide electrical communication between a second electrical conductor 38 on the upper medium 22 and the second doped region 26. The type of dopant in a tertiary doped regions 36 and the second doped regions 26 can be the same, however, the concentration of the dopant in the one of the tertiary doped regions 36 can be higher than the concentration of the dopant in the second doped region 26 contacted by that tertiary doped region 36. As an example, when the second doped regions 26 are N-type regions, the concentration of the N-type dopant in the tertiary doped regions 36 can exceed the concentration of the N-type dopant in the second doped region 26 contacted by that tertiary doped region 36. Although it is possible to place the second electrical conductors 38 directly into contact with one of the second doped regions 26 rather than use the tertiary doped region 36, the tertiary doped region 36 reduces the resistance associated with direct electrical communication between a second electrical conductor 38 and a second doped region 26. A suitable material for the second electrical conductor 38 includes, but is not limited to, a metal.

In some instances, the material that is doped in the tertiary doped regions 36 is different than the material in the upper medium 22. For instance, the doped material in the tertiary doped regions 36 can be silicon or polysilicon while the upper medium 22 is silica. The use of doped silicon or polysilicon can further reduce the electrical resistance associated with electrical communication between the second electrical conductor 38 and the second doped region 26.

Third electrical conductors 40 each extends through the upper medium 22 and into contact with a different one of the third doped regions 28. The concentration of the dopant in the third doped region 28 can be higher than the concentration of dopant in the first doped region 24 and in the second doped region 26. The reduced electrical resistance associated with the elevated dopant concentration reduces the need for an additional doped region between the third electrical conductor 40 and the third doped region 28 although an additional doped region could be employed. A suitable material for the third electrical conductors 40 includes, but is not limited to, a metal.

Electronics can be in electrical communication with the first electrical conductor 32, the second electrical conductors 38, and the third electrical conductors 40. The electronics can be employed to apply electrical energy to the first doped region 24, the second doped regions 26, and the third doped regions 28. The electronics can apply the electrical energy so the bipolar junction transistor is operated with the first doped region 24 as a collector, each of the second doped regions 26 as a base, and each of the third doped regions 28 as an emitter. For instance, the electronics can apply a forward bias between the third doped regions 28 and the second doped regions 26 and a reverse bias between the second doped regions 26 and the first doped region 24. Alternately, the electronics can apply the electrical energy so the bipolar junction transistor is operated with the first doped region 24 as an emitter, each of the second doped regions 26 as a base, and each of the third doped regions 28 as a collector. For instance, the electronics can apply a reverse bias between the third doped regions 28 and the second doped regions 26 and a forward bias between the second doped region 26 and the first doped region 24. However, in circumstances where the concentration of the dopant in the third doped region 28 is higher than the concentration of the dopant in the first doped region 24, it may be desirable for the electronics to operate the bipolar junction transistor with the first doped region 24 serving as the collector.

Changing the current flow through the bipolar junction transistor changes the number of charge carriers in the first doped region 24. When the bipolar junction transistors are PNP transistors and the bipolar junction transistor are operated such that the first doped region 24 serves as the collector, increasing the current flow through the first doped region 24 increases the concentration of holes in the first doped region 24. In contrast, when the bipolar junction transistors are NPN transistors and the bipolar junction transistor is operated such that the first doped region 24 serves as the collector, increasing the current flow through the first doped region 24 increases the concentration of electrons in the first doped region 24. Since the first doped region 24 includes the light signal-carrying region of the waveguide, changing the concentration of charge carriers in the first doped region alters the index of refraction of the light signal-carrying region and accordingly changes the speed at which the light signal travels through the waveguide. Accordingly, the speed of the light signal through the waveguide can be tuned by tuning the flow of electrical current through the bipolar junction transistor and particularly through the light-signal-carrying region. For instance, the speed of the light signal through the waveguide can be tuned by tuning the flow of electrical current through the first doped region 24.

The signals that the electronics apply to the second doped regions and the third doped regions can be the same. As a result, the electronics can operate each of the bipolar junction transistors as is they were connected in parallel. Further, the electronics can physically connect the bipolar junction transistors in parallel. For instance, the electronics can include an electrical conductor that directly connects the second doped regions 26 to one another and an electrical conductor that directly connects the third doped regions 28 to one another. Alternately, the signals that the electronics apply to the second doped regions can be different and/or the signals that the electronics apply to the third doped regions 28 can be different. As a result, the current through the light signal-carrying region can be primarily generated from one of the bipolar junction transistors. Such a configuration may be more efficient in instances where the modulator is positioned along a curved waveguide.

The bipolar junction transistors can be constructed such that one or more of the primary doped regions are positioned within the light signal-carrying region of the waveguide. As is evident in FIG. 2, the bipolar junction transistor is preferably constructed such that no more than one of the primary doped regions is positioned within the light signal-carrying region of the waveguide and the other primary doped regions are excluded from the light signal-carrying region. Additionally or alternately, the light signal-carrying region can include no more than one of the primary doped regions and can exclude the other primary doped regions. In one example, the bipolar junction transistors are preferably constructed such that only the first doped region 24 is positioned within the light signal-carrying region and the second doped regions 26 and the third doped regions 28 are excluded from the light signal-carrying region. When no more than one of the primary doped regions is located in the light signal-carrying region, the light signal-carrying region excludes junctions between primary doped region and the modulator is accordingly not associated with the optical loss resulting from these junctions.

In some instance, the light signal-carrying region does not extend outside of the primary doped regions. For instance, the bipolar junction transistor can be constructed such that the light signal-carrying region does not extend beyond one of the primary doped regions. FIG. 2 illustrates the bipolar junction transistors constructed such that the light signal-carrying region does not extend beyond the first doped region 24. Constructing the bipolar junction transistors without the light signal-carrying region extending beyond one of the primary doped regions can enhance the efficiency of the modulator by increasing the portion of the light signal-carrying region that is exposed to the injected charge carriers.

The maximum modulation speed that can be achieved by the bipolar junction transistor can be a function of the width of the second doped regions 26. For instance, decreasing the width of the second doped regions 26 can increase the maximum possible modulation speed. A suitable width for one or both of the second doped regions 26 includes a width less than 5 μm, 2 μm, or 0.5 μm.

A suitable concentration for the dopant in the first doped region 24 includes concentrations greater than 1×10¹⁰/cm³, 1×10¹³/cm³, or 1×10¹⁵/cm³ and/or less than 1×10¹⁷/cm³, 1×10¹⁹/cm³, or 1×10²¹/cm³. In one example, the first doped region 24 is a p-type dopant with a concentration of about 4×10¹⁶/cm³. A suitable concentration for the dopant in the second doped region 26 includes concentrations greater than 1×10¹⁴/cm³, 1×10¹⁶/cm³, or 1×10¹⁸/cm³ and/or less than 1×10¹⁷/cm³, 1×10¹⁹/cm³, or 1×10²¹/cm³. In one example, the second doped region 26 is an n-type dopant with a concentration of about 1×10¹⁷/cm³. A suitable concentration for the dopant in the third doped region 28 includes concentrations greater than 1×10¹⁵/cm³, 1×10¹⁷/cm³, or 1×10¹⁹/cm³ and/or less than 1×10¹⁷/cm³, 1×10¹⁹/cm³, or 1×10²¹/cm³. In one example, the third doped region 28 is a p-type dopant with a concentration of about 1×10²⁰/cm³. A suitable concentration for the dopant in the secondary doped region 30 includes concentrations greater than 1×10¹⁷/cm³, 1×10¹⁹/cm³, or 5×10¹⁹/cm³ and/or less than 1×10¹⁸/cm³, 1×10²⁰/cm³, or 1×10²²/cm³. In one example, the secondary doped region 30 is a p-type dopant with a concentration of about 1×10²⁰/cm³. A suitable concentration for the dopant in the tertiary doped region 36 include concentrations greater than 1×10¹⁶/cm³, 1×10¹⁸/cm³, or 1×10²⁰/cm³ and/or less than 1×10¹⁹/cm³, 1×10²⁰/cm³, or 1×10²²/cm³. In one example, the tertiary doped region is an n-type dopant with a concentration of about 1×10²⁰/cm³.

A first dopant ratio (concentration of the dopant in the secondary doped region 30: concentration of the dopant in the first doped region 24) can be greater than 1:1, 10:1, or 100:1 and/or less than 1×10⁶, 1×10⁸, or 1×10¹⁰. A second dopant ratio (concentration of the dopant in the third doped region 28: concentration of the dopant in the second doped region 26) can be greater than 1:1, 10:1, 100:1 and/or less than 100:1, 1×10⁴:1, 1×10⁸. A third dopant ratio (concentration of the dopant in the third doped region 28: concentration of the dopant in the first doped region 24) can be greater than 1:1, 1×10²:1, or 1×10⁴:1 and/or less than 1×10²⁰:1, 1×10¹⁶:1, 1×10¹²:1. A fourth dopant ratio (concentration of the dopant in the tertiary doped region 36: concentration of the dopant in the second doped region 26) can be greater than 1:1, 1×10²:1, or 1×10⁴:1 and/or less than 1×10⁸:1, 1×10⁶:1, or 1×10⁴:1.

Although the primary doped regions are shown extending through the first light-transmitting medium 10, the primary doped regions can extend only part way into the first light-transmitting medium 10.

Although FIG. 2 illustrates two secondary doped regions 36 contacting the top of the ridge 16, the modulator can be constructed with a single secondary doped region 36 contacting the top of the ridge.

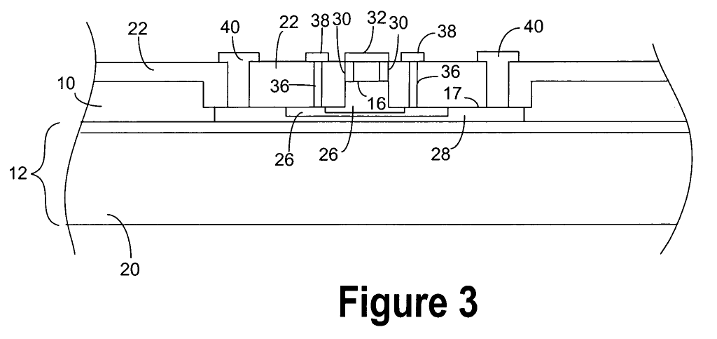

More than one of the primary doped regions can be positioned in the light signal-carrying region. For instance, FIG. 3 illustrates a phase modulator having three of the primary doped regions positioned in the signal-carrying region of the waveguide. Each of the three primary doped regions extends through the light signal-carrying region of the waveguide.

The primary doped regions include a first doped region 24, a second doped region 26, and a third doped region 28. The primary doped regions form a bipolar junction transistor having the second doped region 26 between the first doped region 24 and the third doped region 28. Each of the primary doped regions contacts one or more of the other primary doped regions. For instance, the bipolar junction transistor includes two junctions. One of the junctions is where the first doped region 24 contacts the second doped region 26 and another one of the junctions is where the second doped region 26 contacts the third doped region 28. In some instances, the bipolar junction transistor includes no more than two junctions. For instance, in addition to the two junctions described above, the first doped region 24 does not contact the third doped region 28.

The bipolar junction transistor can be a PNP type transistor or can be an NPN type transistor. For instance, the first doped region 24 and the third doped region 28 can include P-type dopants and can accordingly be P-type regions while the second doped region 26 can include an N-type dopant and can accordingly be a N-type region. Alternately, the first doped region 24 and the third doped region 28 can include N-type dopants and can accordingly be N-type regions while the second doped region 26 can include an P-type dopant and can accordingly be a P-type region. Suitable dopants for n-type regions include, but are not limited to, phosphorus and/or arsenic. Suitable dopants for p-type regions include, but are not limited to, boron.

There are secondary doped regions 30 in the upper medium 22. Each of the secondary doped regions 30 contacts the top of the ridge 16 and is spaced apart from the other secondary doped regions 30 on the top of the ridge. In some instances, the secondary doped regions 30 contact opposing corners of the ridge 16. The secondary doped regions 30 each contacts the first doped region 24 and do not contact the second doped region 26 or the third doped region 28. The secondary doped region 30 can serve to provide electrical communication between the first doped region 24 and a first electrical conductor 32 on the upper medium 22. The type of dopant in the secondary doped region 30 and the first doped region 24 can be the same, however, the concentration of the dopant in the secondary doped region 30 can be higher than the concentration of the dopant in the first doped region 24. As an example, when the first doped region 24 is a P-type region, the concentration of P-type dopant in the secondary doped region 30 can exceed the concentration of the P-type dopant in the first doped region 24. Although it is possible to place the first electrical conductor 32 directly into contact with the first doped region 24 rather than use the secondary doped region 30, the increased dopant concentration in the secondary doped region 30 reduces the resistance associated with direct electrical communication between the first electrical conductor 32 and the first doped region 24. A suitable material for the first electrical conductor 32 includes, but is not limited to, a metal.

In some instances, the material that is doped in the secondary doped regions 30 is different than the material in the upper medium 22. For instance, the doped material in the secondary doped regions 30 can be silicon or polysilicon while the upper medium 22 is silica. The use of doped silicon or polysilicon can further reduce the electrical resistance associated with electrical communication between the second electrical conductor 38 and the second doped region 26.

There are tertiary doped regions 36 in the upper medium 22. The tertiary doped regions 36 each contacts the second doped region 26 but does not contact the first doped region 24 or the third doped region 28. The tertiary doped region 36 can each serve to provide electrical communication between a second electrical conductor 38 on the upper medium 22 and the second doped region 26. The type of dopant in a tertiary doped regions 36 and the second doped regions 26 can be the same, however, the concentration of the dopant in a tertiary doped region 36 can be higher than the concentration of the dopant in the second doped region 26. As an example, when the second doped regions 26 are N-type regions, the concentration of the N-type dopant in the tertiary doped regions 36 can exceed the concentration of the N-type dopant in the second doped region 26. Although it is possible to place the second electrical conductors 38 directly into contact with one of the second doped regions 26 rather than use the tertiary doped region 36, the tertiary doped region 36 reduces the resistance associated with direct electrical communication between a second electrical conductor 38 and a second doped region 26. A suitable material for the second electrical conductor 38 includes, but is not limited to, a metal.

In some instances, the material that is doped in the tertiary doped regions 36 is different than the material in the upper medium 22. For instance, the doped material in the tertiary doped regions 36 can be silicon or polysilicon while the upper medium 22 is silica. The use of doped silicon or polysilicon can further reduce the electrical resistance associated with electrical communication between the second electrical conductor 38 and the second doped region 26.

Third electrical conductors 40 each extend through the upper medium 22 and into contact with the third doped region 28. The concentration of the dopant in the third doped region 28 can be higher than the concentration of dopant in the first doped region 24 and in the second doped region 26. The reduced electrical resistance associated with the elevated dopant concentration reduces the need for an additional doped region between the third electrical conductor 40 and the third doped region 28 although an additional doped region could be employed. A suitable material for the third electrical conductors 40 includes, but is not limited to, a metal.

Electronics can be in electrical communication with the first electrical conductor 32, the second electrical conductor 38, and the third electrical conductor 40. The electronics can be employed to apply electrical energy to the first doped region 24, the second doped region 26, and the third doped region 28. The electronics can apply the electrical energy so the bipolar junction transistor is operated with the first doped region 24 as the collector, the second doped region 26 as the base, and the third doped region 28 as the emitter. For instance, the electronics can apply a forward bias between the third doped region 28 and the second doped region 26 and a reverse bias between the second doped region 26 and the first doped region 24. Alternately, the electronics can apply the electrical energy so the bipolar junction transistor is operated with the first doped region 24 as the emitter, the second doped region 26 as the base, and the third doped region 28 as the collector. For instance, the electronics can apply a reverse bias between the third doped region 28 and the second doped region 26 and a forward bias between the second doped region 26 and the first doped region 24. However, in circumstances where the concentration of the dopant in the third doped region 28 is higher than the concentration of the dopant in the first doped region 24, it may be desirable for the electronics to operate the bipolar junction transistor with the first doped region 24 serving as the collector.

Changing the current flow through the bipolar junction transistor changes the number of charge carriers in at least the first doped region 24. When the bipolar junction transistor is an PNP transistor and the bipolar junction transistor is operated such that the first doped region 24 serves as the collector, increasing the current flow through the first doped region 24 increases the concentration of holes in the first doped region 24. In contrast, when the bipolar junction transistor is an NPN transistor and the bipolar junction transistor is operated such that the first doped region 24 serves as the collector, increasing the current flow through the first doped region 24 increases the concentration of electrons in the first doped region 24. Since the light signal-carrying region of the waveguide includes the first doped region 24, changing the concentration of charge carriers in the first doped region alters the index of refraction of the light signal-carrying region and accordingly changes the speed at which the light signal travels through the waveguide. Accordingly, the speed of the light signal through the waveguide can be tuned by tuning the flow of electrical current through the bipolar junction transistor and particularly through the light-signal-carrying region. For instance, the speed of the light signal through the waveguide can be tuned by tuning the flow of electrical current through the first doped region 24.

The signals that the electronics apply to the tertiary doped regions 36 can be the same. For instance, the second electrical conductors 38 can be in direct electrical communication with one another. Additionally or alternately, the signals that the electronics apply to the third electrical conductors 40 can be the same. For instance, the third electrical conductors 40 can be in direct electrical communication with one another.

The maximum modulation speed that can be achieved by the bipolar junction transistor can be a function of the thickness of the portion of the second doped region 26 that is in the light signal-carrying region of the waveguide. For instance, decreasing the thickness of the portion of the second doped region 26 that is in the light signal-carrying region of the waveguide can increase the maximum possible modulation speed. A suitable thickness for the portion of the second doped region 26 that is in the light signal-carrying region of the waveguide includes a thickness less than 5 μm, 2 μm or 0.5 μm.

A suitable concentration for the dopant in the first doped region 24 includes concentrations greater than 1×10¹⁰/cm³, 1×10¹³/cm³, or 1×10¹⁵/cm³ and/or less than 1×10¹⁷/cm³, 1×10¹⁹/cm³, or 1×10²¹/cm³. In one example, the first doped region 24 is a p-type dopant with a concentration of about 4×10¹⁶/cm³. A suitable concentration for the dopant in the second doped region 26 includes concentrations greater than 1×10¹⁴/cm³, 1×10¹⁶/cm³, or 1×10¹⁸/cm³ and/or less than 1×10¹⁷/cm³, 1×10¹⁹/cm³, or 1×10²¹/cm³. In one example, the second doped region 26 is an n-type dopant with a concentration of about 1×10¹⁷/cm³. A suitable concentration for the dopant in the third doped region 28 includes concentrations greater than 1×10¹⁵/cm³, 1×10¹⁷/cm³, or 1×10¹⁹/cm³ and/or less than 1×10¹⁷/cm³, 1×10¹⁹/cm³, or 1×10²¹/cm³. In one example, the third doped region 28 is a p-type dopant with a concentration of about 1×10²⁰/cm³. A suitable concentration for the dopant in the secondary doped region 30 includes concentrations greater than 1×10¹⁷/cm³, 1×10¹⁹/cm³, or 5×10¹⁹/cm³ and/or less than 1×10¹⁸/cm³, 1×10²⁰/cm³, or 1×10²²/cm³. In one example, the secondary doped region 30 is a p-type dopant with a concentration of about 1×10²⁰/cm³. A suitable concentration for the dopant in the tertiary doped region 36 include concentrations greater than 1×10¹⁶/cm³, 1×10¹⁸/cm³, or 1×10²⁰/cm³ and/or less than 1×10¹⁹/cm³, 1×10²⁰/cm³, or 1×10²²/cm³. In one example, the tertiary doped 36 is an n-type dopant with a concentration of about 1×10²⁰/cm³.

A first dopant ratio (concentration of the dopant in the secondary doped region 30: concentration of the dopant in the first doped region 24) can be greater than 1:1, 10:1, or 100:1 and/or less than 1×10⁶, 1×10⁸, or 1×10¹⁰. A second dopant ratio (concentration of the dopant in the third doped region 28: concentration of the dopant in the second doped region 26) can be greater than 1:1, 10:1, 100:1 and/or less than 100:1, 1×10⁴:1, 1×10⁸. A third dopant ratio (concentration of the dopant in the third doped region 28: concentration of the dopant in the first doped region 24) can be greater than 1:1, 1×10²:1, or 1×10⁴:1 and/or less than 1×10²⁰:1, 1×10¹⁶:1, 1×10¹²:1. A fourth dopant ratio (concentration of the dopant in the tertiary doped region 36: concentration of the dopant in the second doped region 26) can be greater than 1:1, 1×10²:1, or 1×10⁴:1 and/or less than 1×10⁸:1, 1×10⁶:1, or 1×10⁴:1

Although FIG. 3 illustrates two secondary doped regions 30 contacting the top of the ridge 16, the modulator can be constructed with a single secondary doped region 30 contacting the top of the ridge. Additionally or alternately, the phase modulator can include only one tertiary doped region 36 and second electrical conductor 38 and/or only one third electrical conductor 40.

The regions of the first light-transmitting medium 10 that are not described above as being doped can be doped, lightly doped, or can exclude dopant. In some instances, all of the regions of the first light-transmitting medium 10 that are not described above as being doped exclude both p-type dopant and n-type dopant.

Although the first electrical conductor 32, the second electrical conductor 38 and the third electrical conductor 40 are disclosed as one piece entities, these conductors can be constructed to several different members, elements, links, or layers in electrical communication with one another.

Although the modulator is disclosed in the context of a phase modulator, the modulator can also serve as an intensity modulator. For instance, one or more of the above phase modulators can be positioned along a branch of a Mach-Zehnder interferometer and can be operated so as to modulate the output of the Mach-Zehnder interferometer. For instance, the phase modulator can be substituted for the phase modulators and/or the sub-modulators disclosed in U.S. patent application Ser. No. 11/146,898; filed on Jun. 7, 2005; entitled “High Speed Optical Phase Modulator;” and incorporated herein in its entirety and also disclosed in U.S. patent application Ser. No. 11/147,403; filed on Jun. 7, 2005; entitled “High Speed Optical Intensity Modulator;” and incorporated herein in its entirety.

The above modulators can be constructed using integrated circuit fabrication technologies and/or electro-optic device fabrication technologies as well as the fabrication methods disclosed in U.S. patent application Ser. No. 11/146,898 and 11/147,403.

Suitable electronics for operating the above phase modulators can include a controller. A suitable controller includes, but is not limited to, a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions attributed to the electronics. A general-purpose processor may be a microprocessor, but in the alternative, the controller may include or consist of any conventional processor, microcontroller, or state machine. A controller may also be implemented as a combination of computing devices, e.g., a combination of a DSP and a microprocessor, a plurality of microprocessors, one or more microprocessors in conjunction with a DSP core, or any other such configuration.

The electronics can optionally include a memory in communication with the controller. The electronics can store data for executing the functions of the electronics in the memory. The memory can be any memory device or combination of memory devices suitable for read and/or write operations.

In some instances, the electronics include a computer-readable medium in communication with the controller. The computer-readable medium can have a set of instructions to be executed by the controller. The controller can read and execute instructions included on the computer-readable medium. The controller executes the instructions such that the electronics perform one or more of the described functions. The computer-readable medium cab be different from the memory or can be the same as the memory. Suitable computer-readable media include, but are not limited to, optical discs such as CDs, magnetic storage diskettes, Zip disks, magnetic tapes, RAMs, and ROMs. Some functions of the electronics may be executed using hardware as opposed to executing these functions in firmware and/or software.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. An optical modulator, comprising:
an optical waveguide positioned on a base, the waveguide configured to guide a light signal through a light signal-carrying region of a light-transmitting medium,
the light signal-carrying region being a region of the waveguide where the fundamental and higher order modes of the light signal are constrained within the waveguide;
a bipolar junction transistor formed in the light-transmitting medium,
the transistor positioned such that causing current to flow through the transistor causes charge carriers to be introduced into the light signal-carrying region of the waveguide,
the transistor being a PNP type transistor or an NPN type transistor.

2. The modulator of claim 1, wherein the transistor includes three doped regions in the light-transmitting medium, each one of the three doped regions contacting one or more of the other doped regions; and
at least one of the doped regions being positioned in the light signal-carrying region of the light-transmitting medium.

3. The modulator of claim 2, wherein the doped regions include a first doped regions and the first doped region is the only one of the doped regions positioned in the light signal-carrying region.

4. The modulator of claim 3, wherein the light signal-carrying region does not extend outside of the first doped region.

5. The modulator of claim 2, further comprising:
electronics configured to operate the bipolar junction transistor such that one of the doped regions act as a collector for the transistor, one of the doped regions act as a base for the transistor, and one of the doped regions act as an emitter for the transistor, and the collector is positioned in the light signal-carrying region of the light-transmitting medium.

6. The modulator of claim 5, wherein the base and the emitter are not positioned in the light signal-carrying region of the light-transmitting medium.

7. The modulator of claim 1, wherein the transistor is the PNP type transistor.

8. The modulator of claim 1, wherein the transistor is the NPN type transistor.

9. A method of modulating light signals, comprising:
causing an electrical current to flow through a bipolar junction transistor formed in a light-transmitting medium positioned on a base,
an optical waveguide positioned on the base, the waveguide configured to guide a light signal through the light signal-carrying region of the light-transmitting medium,
the light signal-carrying region being a region of the waveguide where the fundamental and higher order modes of the light signal are constrained within the waveguide,
wherein causing the current to flow through the transistor causes charge carriers to be introduced into the light signal-carrying region of the waveguide, and
the transistor being a PNP type transistor or an NPN type transistor.

10. The method of claim 9, wherein the transistor includes three doped regions in the light-transmitting medium, each one of the three doped regions contacting one or more of the other doped regions; and
at least one of the doped regions being positioned in the light signal-carrying region of the light-transmitting medium.

11. The method of claim 10, wherein the doped regions include a first doped regions and the first doped region is the only one of the doped regions positioned in the light signal-carrying region.

12. The method of claim 11, wherein the light signal-carrying region does not extend outside of the first doped region.

13. The method of claim 10, further comprising:
electronics configured to operate the bipolar junction transistor such that one of the doped regions act as a collector for the transistor, one of the doped regions act as a base for the transistor, and one of the doped regions act as an emitter for the transistor, and the collector is positioned in the light signal-carrying region of the light-transmitting medium.

14. The method of claim 13, wherein the base and the emitter are not positioned in the light signal-carrying region of the light-transmitting medium.

15. The method of claim 9, wherein the transistor is the PNP type transistor.

16. The method of claim 9, wherein the transistor is the NPN type transistor.
